(19) United States
(12) Patent Application Publication
(10) Pub. No.: US 2018/0186073 A1
(43) Pub. Date: Jul. 5, 2018

(54) ADDITIVE MANUFACTURING SYSTEMS INCLUDING A PARTICULATE DISPENSER AND METHODS OF OPERATING SUCH SYSTEMS

(71) Applicant: GENERAL ELECTRIC COMPANY, Schnectady, NY (US)

(72) Inventors: Laura Cerully Dial, Clifton Park, NY (US); Anthony Joseph Vinciquerra, Rexford, NY (US); Scott Michael Oppenheimer, Schenectady, NY (US)

(21) Appl. No.: 15/859,910

(22) Filed: Jan. 2, 2018

Related U.S. Application Data
(60) Provisional application No. 62/441,718, filed on Jan. 3, 2017.

(51) Int. Cl. B29C 64/209; B29C 64/153; B33Y 10/00; B33Y 30/00

(52) U.S. Cl. CPC B29C 64/209; B33Y 30/00; B33Y 10/00; B29C 64/153

(57) ABSTRACT

An additive manufacturing system includes a particulate delivery system including at least one dispenser configured to dispense a plurality of first particulates and a plurality of second particulates onto a surface. The particulate delivery system includes a first particulate supply and a second particulate supply coupled to the at least one dispenser. The at least one dispenser is configured to deposit the plurality of first particulates and the plurality of second particulates adjacent each other. At least a portion of at least one of the plurality of first particulates and the plurality of second particulates is fused.

### CROSS REFERENCE TO RELATED APPLICATIONS

This application claims priority to U.S. provisional patent application Ser. No. 62/441,718, filed Jan. 3, 2017, which is hereby incorporated by reference in its entirety.

### BACKGROUND

The subject matter disclosed herein relates generally to additive manufacturing systems and, more particularly, to additive manufacturing systems including a dispenser for dispensing particulates onto a surface.

Additive manufacturing systems involve the buildup of a material to make a component. These systems can produce complex components from expensive materials at a reduced cost and with improved manufacturing efficiency. Some known additive manufacturing systems, such as Direct Metal Laser Melting (DMLM), Selective Laser Sintering (SLS), Direct Metal Laser Sintering (DMLS), Selective Laser Melting (SLM), Electron Beam Melting (EBM), and LaserCusing systems, fabricate components using a focused energy source, such as a laser device or an electron beam generator, and a particulate, such as a powdered metal. In such additive manufacturing systems, the properties of the component are at least partially determined by the properties of the particulate used to form the component. However, it is sometimes desirable to provide components having variations and localized properties. Accordingly, sometimes, two or more components having different properties are joined together. However, the joined components have an increased cost to assemble and can have a reduced expected service life in comparison to single components due to the joint(s) between the components. In addition, the design possibilities of the joined components are limited by known methods to join components.

### BRIEF DESCRIPTION

In one aspect, an additive manufacturing system is provided. The additive manufacturing system includes a particulate delivery system including at least one dispenser configured to dispense a plurality of first particulates and a plurality of second particulates onto a surface. The particulate delivery system includes a first particulate supply and a second particulate supply coupled to the at least one dispenser. The at least one dispenser is configured to deposit the plurality of first particulates and the plurality of second particulates adjacent to each other. At least a portion of at least one of the plurality of first particulates and the plurality of second particulates is fused.

In another aspect, a method of manufacturing a part using an additive manufacturing system is provided. The method includes depositing a plurality of first particulates. The method also includes depositing a plurality of second particulates. The plurality of second particulates is deposited adjacent the plurality of first particulates. The method further includes heating at least a portion of at least one of the plurality of first particulates and the plurality of second particulates using a first focused energy source.

In yet another aspect, an additive manufacturing system is provided. The additive manufacturing system includes a displacement assembly configured to displace at least a portion of a plurality of first particulates and at least partially form a recess. The additive manufacturing system further includes at least one dispenser configured to dispense a plurality of second particulates. The at least one dispenser is configured to dispense at least a portion of the plurality of second particulates at least partially into the recess. The additive manufacturing system also includes at least one focused energy source configured to heat at least a portion of at least one of the plurality of first particulates and the plurality of second particulates.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an exemplary additive manufacturing system;

FIG. 2 is a schematic view of a portion of the additive manufacturing system shown in FIG. 1 including a particulate delivery system;

FIG. 3 is a schematic plan view of a portion of the additive manufacturing system shown in FIG. 1 including the particulate delivery system shown in FIG. 2;

FIG. 4 is a schematic plan view of a plurality of first particulates and a plurality of second particulates deposited on a surface of the additive manufacturing system shown in FIG. 1;

FIG. 5 is a schematic view of an alternative embodiment of a particulate delivery system for use with the additive manufacturing system shown in FIG. 1;

FIG. 6 is a perspective view of an exemplary additive manufacturing system; and

FIG. 7 is a perspective view of a particulate delivery system of the additive manufacturing system shown in FIG. 6.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, a programmable logic controller (PLC), and application specific integrated circuit, and other programmable circuits, and these terms are used interchangeably herein. In the embodiments described herein, memory may include, but it not limited to, a computer-readable medium, such as a random access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include any computer program storage in memory for execution by personal computers, workstations, clients, and servers.

As used herein, the term “non-transitory computer-readable media” is intended to be representative of any tangible computer-based device implemented in any method of technology for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including without limitation, volatile and non-volatile media, and removable and non-removable media such as firmware, physical and virtual storage, CD-ROMS, DVDs, and any other digital source such as a network or the Internet, as well as yet to be developed digital means, with the sole exception being transitory, propagating signal.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

The systems and methods described herein relate to additive manufacturing systems, such as Direct Metal Laser Melting (DMLM) systems. The embodiments described herein include a focused energy source and a particulate delivery system. The particulate delivery system is configured to deposit a plurality of first particulates and a plurality of second particulates onto a surface. In some embodiments, the particulate delivery system includes at least one dispenser configured to dispense the first particulates and the second particulates. In further embodiments, at least a portion of the first particulates are displaced to at least partially form a recess and at least a portion of the second particulates are deposited at least partially into the recess. Accordingly, the described embodiments allow components to have localized properties. For example, different particulates are included within the same layer during a build of the component to facilitate localization of properties within the component.

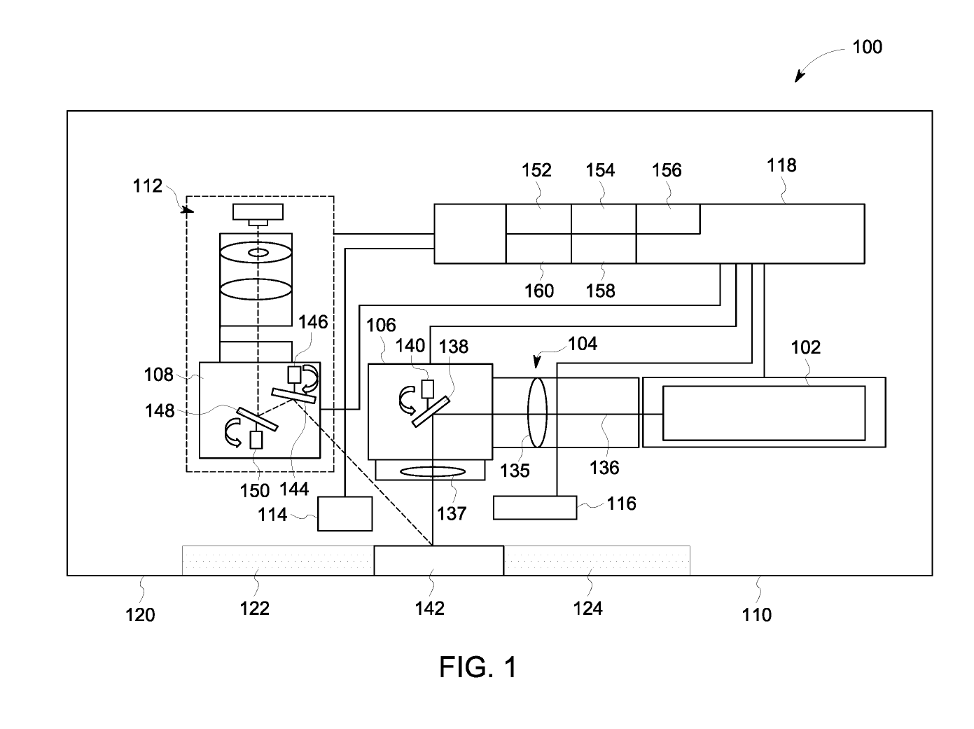

FIG. 1 is a schematic view of an exemplary additive manufacturing system 100. In the exemplary embodiment, additive manufacturing system 100 is a direct metal laser melting (DMLM) system. In alternative embodiments, additive manufacturing system 100 is configured for use for any additive manufacturing process that enables additive manufacturing system 100 to operate as described herein. For example, in some embodiments, additive manufacturing system 100 is used for any of the following processes: Selective Laser Sintering (SLS), Direct Metal Laser Sintering (DMLS), Selective Laser Melting (SLM) and LaserCusing.

In the exemplary embodiment, additive manufacturing system 100 includes a focused energy source 102, optical elements 104, a first scanning device 106, a second scanning device 108, a housing 110, an optical system 112, a displacement device 114, a particulate delivery system 116, and a controller 118. In alternative embodiments, additive manufacturing system 100 includes any component that enables additive manufacturing system 100 to operate as described herein.

Also, in the exemplary embodiment, housing 110 defines a surface or build plate 120 configured to hold first particulates 122 and second particulates 124. In addition, housing 110 provides a controlled environment for housing components of additive manufacturing system 100 such as particulate delivery system 116. In alternative embodiments, additive manufacturing system 100 includes any housing 110 that enables additive manufacturing system 100 to operate as described herein.

In addition, in the exemplary embodiment, first particulates 122 and second particulates 124 are powdered build materials that are melted and re-solidified during the additive manufacturing process to build a solid component. In the exemplary embodiment, first particulates 122 and second particulates 124 each include a powder alloy of any of the following: cobalt, iron, aluminum, titanium, nickel, and combinations thereof. In alternative embodiments, first particulates 122 and second particulates 124 include any material that enables additive manufacturing system 100 to operate as described herein. For example, in some embodiments, first particulates 122 and/or second particulates 124 includes, without limitation, any of the following: ceramic powders, metal-coated ceramic powders, thermoset resins, and thermoplastic resins. In further embodiments, additive manufacturing system 100 utilizes any number of particulates, e.g., third particulates, fourth particulates, etc.

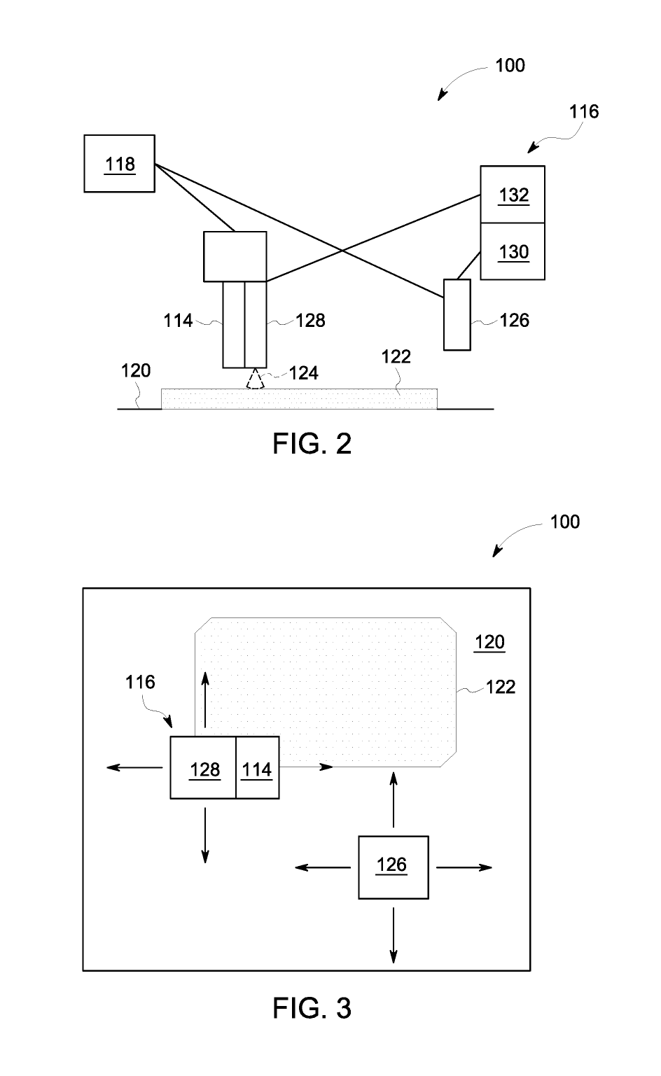

FIG. 2 is a schematic view of a portion of additive manufacturing system 100 including particulate delivery system 116. Particulate delivery system 116 includes a first dispenser 126, a second dispenser 128, a first particulate supply 130, and a second particulate supply 132. At least a portion of particulate delivery system 116 is enclosed within housing 110. In particular, first dispenser 126, second dispenser 128, first particulate supply 130, and second particulate supply 132 are positioned within the controlled environment of housing 110 to inhibit exposure of first particulates 122 and second particulates 124 to the ambient environment. In alternative embodiments, particulate delivery system 116 is positioned anywhere in additive manufacturing system 100 that enables additive manufacturing system 100 to operate as described herein.

In the exemplary embodiment, first dispenser 126 and second dispenser 128 are positioned above surface 120 and configured to deposit first particulates 122 and second particulates 124 onto surface 120. In particular, first dispenser 126 is coupled to first particulate supply 130 and configured to dispense first particulates 122 from first particulate supply 130 onto surface 120. Second dispenser 128 is coupled to second particulate supply 132 and is configured to dispense second particulates 124 from second particulate supply 132 onto surface 120. Accordingly, first dispenser 126 and second dispenser 128 facilitate depositing different particulates 122, 124 onto surface 120. In alternative embodiments, additive manufacturing system 100 includes any dispenser that enables additive manufacturing system 100 to operate as described herein. For example, in some embodiments, particulate delivery system 116 includes a powder bed and a transfer mechanism to deposit at least one of first particulates 122 and second particulates 124 onto surface 120.

Also, in the exemplary embodiment, displacement device 114 is configured to displace at least one of first particulates 122 and second particulates 124 when first particulates 122 and/or second particulates 124 are on surface 120. For example, in some embodiments, displacement device 114 includes a tool configured to contact at least one of first particulates 122 and second particulates 124 and thereby displace a portion of at least one of first particulates 122 and second particulates 124. In further embodiments, displacement device 114 includes a vacuum system that is configured to remove a portion of at least one of first particulates 122 and second particulates 124 from surface 120. In some embodiments, displacement device 114 includes a source of pressurized fluid and a nozzle to direct pressurized fluid towards at least one of first particulates 122 and second particulates 124. In the exemplary embodiment, displacement device 114 displaces first particulates 122 to form desired shapes, such as recesses, in first particulates 122. In alternative embodiments, additive manufacturing system 100 includes any displacement device 114 that enables additive manufacturing system 100 to operate as described herein.

FIG. 3 is a schematic plan view of a portion of additive manufacturing system 100 including particulate delivery system 116. At least a portion of particulate delivery system 116 is configured to move relative to surface 120. In particular, first dispenser 126 and second dispenser 128 are configured to move laterally relative to surface 120. In addition, first dispenser 126 and second dispenser 128 are configured to move towards and away from surface 120. Accordingly, particulate delivery system 116 is configured to deposit at least one of first particulates 122 and second particulates 124 in any pattern on surface 120. In alternative embodiments, particulate delivery system 116 is configured to move in any manner that enables additive manufacturing system 100 to operate as described herein.

In addition, in the exemplary embodiment, displacement device 114 is configured to move relative to surface 120. In particular, displacement device 114 is configured to move laterally relative to surface 120. In addition, displacement device 114 is configured to move towards and away from surface 120. Accordingly, displacement device 114 is configured to displace any portion of first particulates 122 and second particulates 124 on surface 120 in any direction. In alternative embodiments, displacement device 114 is configured to move in any manner that enables additive manufacturing system 100 to operate as described herein.

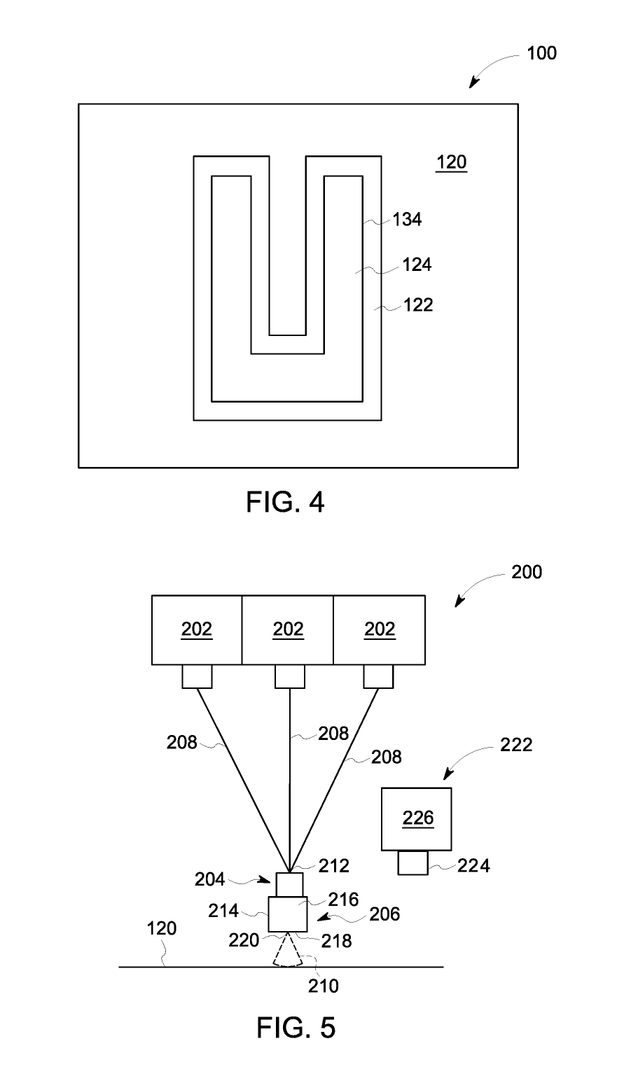

FIG. 4 is a schematic plan view of first particulates 122 and second particulates 124 deposited on surface 120 of additive manufacturing system 100. First particulates 122 form a U-shape on surface 120. Displacement device 114 (shown in FIG. 3) has displaced a portion of first particulates 122 to form a recess or trench 134. Recess 134 extends through a portion of first particulates 122 and is configured to receive second particulates 124. A portion of second particulates 124 is deposited at least partially within recess 134. In particular, second particulates 124 are deposited within recess 134 such that first particulates 122 and second particulates 124 extend along the same plane. Accordingly, displacement device 114 and particulate delivery system 116 facilitate building a component from first particulates 122 and second particulates 124 within the same layer. In alternative embodiments, first particulates 122 and/or second particulates 124 are deposited on surface 120 in any manner that enables additive manufacturing system 100 to operate as described herein.

In the exemplary embodiment, recess 134 has a U-shape that corresponds to the shape of first particulates 122. Recess 134 is defined within the interior of first particulates 122, i.e., recess 134 is spaced inward from a perimeter of first particulates 122. In the exemplary embodiment, displacement device 114 (shown in FIG. 3) displaces first particulates 122 such that recess 134 extends the entire depth of first particulates 122. In alternative embodiments, displacement device 114 (shown in FIG. 3) forms any recess 134 that enables additive manufacturing system 100 to operate as described herein. For example, in some embodiments, recess 134 has a different shape than first particulates 122. In further embodiments, recess 134 extends through only a portion of first particulates 122.

Also, in the exemplary embodiment, first particulates 122 and second particulates are substantially level. In addition, second particulates 124 are deposited within recess 134 with substantially the same thickness as first particulates 122. Accordingly, screeding or leveling of first particulates 122 and second particulates 124 is not required. Omitting the process of screeding first particulates 122 and/or second particulates 124 reduces mixing that occurs during screeding. In some embodiments, first particulates 122 and/or second particulates 124 are screeded or leveled. For example, in some embodiments, first particulates 122 are screeded prior to deposition of second particulates 124. In further embodiments, first particulates 122 are at least partially affixed in position on surface 120 to allow screeding of second particulates 124.

In reference to FIGS. 3 and 4, second dispenser 128 is coupled to displacement device 114 to facilitate depositing second particulates 124 at least partially within recess 134. In particulate, second dispenser 128 and displacement device 114 are configured such that second dispenser 128 deposits second particulates 124 directly into recess 134 and substantially simultaneous with displacement device 114 forming recess 134. Accordingly, the configuration of second dispenser 128 and displacement device 114 facilitate second particulates 124 filling and supporting recess 134. As a result, first particulates 122 are inhibited from moving into recess 134 after displacement device 114 displaces first particulates 122. In alternative embodiments, recess 134 is formed in any manner that enables additive manufacturing system 100 to operate as described herein. For example, in some embodiments, displacement device 114 and second dispenser 128 are separate.

In reference to FIG. 1, in the exemplary embodiment, focused energy source 102 is configured to heat at least one of first particulates 122 and second particulates 124. Focused energy source 102 is optically coupled to optical elements 104 and first scanning device 106. Optical elements 104 and first scanning device 106 are configured to facilitate controlling the scanning of focused energy source 102. In the exemplary embodiment, focused energy source 102 is a laser device such as a yttrium-based solid state laser configured to emit a laser beam 136 having a wavelength of about 1070 nanometers (nm). In alternative embodiments, additive manufacturing system 100 includes any focused energy source 102 that enables additive manufacturing system 100 to operate as described herein. For example, in some embodiments, additive manufacturing system 100 includes a first focused energy source 102 having a first power and a second focused energy source 102 having a second power different from the first power. In further embodiments, additive manufacturing system 100 includes at least two focused energy sources 102 having substantially the same power output. In further embodiments, additive manufacturing system 100 includes at least one focused energy source 102 that is an electron beam generator. In some embodiments, additive manufacturing system 100 includes a diode fiber laser array including a plurality of diode lasers and a plurality of optical fibers. In such embodiments, the diode fiber array simultaneously directs laser beams from optical fibers towards surface 120 to heat at least one of first particulates 122 and second particulates 124.

In further embodiments, first particulates 122 and/or second particulates 124 are fused in any manner that enables system 100 to operate as described herein. For example, in some embodiments, a binder is used to fuse first particulates 122 and/or second particulates 124. In such embodiments, focused energy source 102 may be omitted.

Moreover, in the exemplary embodiment, optical elements 104 facilitate focusing beam 136 on surface 120. In the exemplary embodiment, optical elements 104 include a beam collimator 135 disposed between focused energy source 102 and first scanning device 106, and an F-theta lens 137 disposed between first scanning device 106 and surface 120. In alternative embodiments, additive manufacturing system 100 includes any optical element that enables additive manufacturing system 100 to operate as described herein.

During operation, in the exemplary embodiment, first scanning device 106 is configured to direct beam 136 across selective portions of surface 120 to create a solid component. In the exemplary embodiment, first scanning device 106 is a galvanometer scanning device including a mirror 138 operatively coupled to a galvanometer-controlled motor 140 (broadly, an actuator). Motor 140 is configured to move (specifically, rotate) mirror 138 in response to signals received from controller 118, and thereby deflect beam 136 towards and across selective portions of surface 120. In some embodiments, mirror 138 includes a reflective coating that has a reflectance spectrum that corresponds to the wavelength of beam 136. In alternative embodiments, additive manufacturing system 100 includes any scanning device that enables additive manufacturing system 100 to operate as described herein. For example, in some embodiments, first scanning device 106 includes two mirrors and two galvanometer-controlled motors, each operatively coupled to one of the mirrors. In further embodiments, first scanning device 106 includes, without limitation, any of the following: two-dimension (2D) scan galvanometers, three-dimension (3D) scan galvanometers, and dynamic focusing galvanometers.

Also, in the exemplary embodiment, optical system 112 is configured to facilitate monitoring a melt pool 142 created by beam 136. In particular, optical system 112 is configured to detect electromagnetic radiation generated by melt pool 142 and transmit information about melt pool 142 to controller 118. More specifically, optical system 112 is configured to receive EM radiation generated by melt pool 142, and generate an electrical signal in response thereto. Optical system 112 is communicatively coupled to controller 118, and is configured to transmit electrical signals to controller 118. In alternative embodiments, additive manufacturing system 100 includes any optical system 112 that enables additive manufacturing system 100 to operate as described herein. For example, in some embodiments, optical system 112 includes, without limitation, any of the following: a photomultiplier tube, a photodiode, an infrared camera, a charged-couple device (CCD) camera, a CMOS camera, a pyrometer, or a high-speed visible-light camera. In further embodiments, optical system 112 is configured to detect EM radiation within an infrared spectrum and EM radiation within a visible-light spectrum. In some embodiments, optical system 112 includes a beam splitter (not shown) configured to divide and deflect EM radiation from melt pool 142 to corresponding optical detectors.

While optical system 112 is described as including “optical” detectors for EM radiation generated by melt pool 142, it should be noted that use of the term “optical” is not equated with the term “visible.” Rather, optical system 112 is configured to capture a wide spectral range of EM radiation. For example, in some embodiments, optical system 112 is sensitive to light with wavelengths in the ultraviolet spectrum (about 200-400 nm), the visible spectrum (about 400-700 nm), the near-infrared spectrum (about 700-1,200 nm), and the infrared spectrum (about 1,200-10,000 nm). Further, because the type of EM radiation emitted by melt pool 142 depends on the temperature of melt pool 142, optical system 112 is capable of monitoring and measuring both a size and a temperature of melt pool 142.

Also in the exemplary embodiment, optical system 112 includes second scanning device 108 which is configured to direct EM radiation generated by melt pool 142. In the exemplary embodiment, second scanning device 108 is a galvanometer scanning device including a first mirror 144 operatively coupled to a first galvanometer-controlled motor 146 (broadly, an actuator), and a second mirror 148 operatively coupled to a second galvanometer-controlled motor 150 (broadly, an actuator). First motor 146 and second motor 150 are configured to move (specifically, rotate) first mirror 144 and second mirror 148, respectively, in response to signals received from controller 118 to deflect EM radiation from melt pool 142 to optical system 112. In some embodiments, one or both of first mirror 144 and second mirror 148 includes a reflective coating that has a reflectance spectrum that corresponds to EM radiation that optical system 112 is configured to detect. In alternative embodiments, additive manufacturing system 100 includes any scanning device that enables additive manufacturing system 100 to operate as described herein.

Additive manufacturing system 100 is operated to fabricate a component by a layer-by-layer manufacturing process. The component is fabricated from an electronic representation of the 3D geometry of the component. In some embodiments, the electronic representation is produced in a computer aided design (CAD) or similar file. In alternative embodiments, the electronic representation is any electronic representation that enables additive manufacturing system 100 to operate as described herein. In the exemplary embodiment, the CAD file of the component is converted into a layer-by-layer format that includes a plurality of build parameters for each layer. In the exemplary embodiment, the component is arranged electronically in a desired orientation relative to the origin of the coordinate system used in additive manufacturing system 100. The geometry of the component is sliced into a stack of layers of a desired thickness, such that the geometry of each layer is an outline of the cross-section through the component at that particular layer location. A “toolpath” or “toolpaths” are generated across the geometry of a respective layer. The build parameters are applied along the toolpath or toolpaths to fabricate that layer of the component from the material used to construct the component. The steps are repeated for each respective layer of the component geometry. Once the process is completed, an electronic computer build file (or files) is generated including all of the layers. The build file is loaded into controller 118 of additive manufacturing system 100 to control the system during fabrication of each layer.

After the build file is loaded into controller 118, additive manufacturing system 100 is operated to generate the component by implementing the layer-by-layer manufacturing process, such as a DMLM method. The exemplary layer-by-layer additive manufacturing process does not use a pre-existing article as the precursor to the final component, rather the process produces the component from a raw material in a configurable form, such as first particulates 122 and second particulates 124. For example, without limitation, a steel component is additively manufactured using a steel powder. Additive manufacturing system 100 enables fabrication of components using a broad range of materials, for example, without limitation, metals, ceramics, and polymers. In alternative embodiments, DMLM fabricates components from any materials that enable additive manufacturing system 100 to operate as described herein.

As used herein, the term “parameter” refers to characteristics that are used to define the operating conditions of additive manufacturing system 100, such as a power output of focused energy source 102, a vector scanning speed of focused energy source 102, a raster power output of focused energy source 102, a raster scanning speed of focused energy source 102, a raster tool path of focused energy source 102, and a contour power output of focused energy source 102 within additive manufacturing system 100. In some embodiments, the parameters are initially input by a user into controller 118. The parameters represent a given operating state of additive manufacturing system 100. In general, during raster scanning, beam 136 is scanned sequentially along a series of substantially straight lines spaced apart and parallel to each other. During vector scanning, beam 136 is generally scanned sequentially along a series of substantially straight lines or vectors, where the orientation of the vectors relative to each other sometimes varies. In general, the ending point of one vector coincides with the beginning point of the next vector. Vector scanning is generally used to define the outer contours of a component, whereas raster scanning is generally used to “fill” the spaces enclosed by the contour, where the component is solid.

In the exemplary embodiment, controller 118 is coupled to particulate delivery system 116 and focused energy source 102. Controller 118 includes a memory device 152 and processor 154 coupled to memory device 152. In some embodiments, processor 154 includes one or more processing units, such as, without limitation, a multi-core configuration. In the exemplary embodiment, processor 154 includes a field programmable gate array (FPGA). Alternatively, processor 154 is any type of processor that permits controller 118 to operate as described herein. In some embodiments, executable instructions are stored in memory device 152. Controller 118 is configurable to perform one or more operations described herein by programming processor 154. For example, processor 154 is programmed by encoding an operation as one or more executable instructions and providing the executable instructions in memory device 152. In the exemplary embodiment, memory device 152 is one or more devices that enable storage and retrieval of information such as executable instructions or other data. In some embodiments, memory device 152 includes one or more computer readable media, such as, without limitation, random access memory (RAM), dynamic RAM, static RAM, a solid-state disk, a hard disk, read-only memory (ROM), erasable programmable ROM, electrically erasable programmable ROM, or non-volatile RAM memory. The above memory types are exemplary only, and are thus not limiting as to the types of memory usable for storage of a computer program.

In some embodiments, memory device 152 is configured to store build parameters including, without limitation, real-time and historical build parameter values, or any other type of data. In alternative embodiments, memory device 152 stores any data that enable additive manufacturing system 100 to operate as described herein. In some embodiments, processor 154 removes or “purges” data from memory device 152 based on the age of the data. For example, processor 154 overwrites previously recorded and stored data associated with a subsequent time or event. In addition, or alternatively, processor 154 removes data that exceeds a predetermined time interval. In addition, memory device 152 includes, without limitation, sufficient data, algorithms, and commands to facilitate monitoring and measuring of build parameters and the geometric conditions of the component fabricated by additive manufacturing system 100.

In some embodiments, controller 118 includes a presentation interface 156 coupled to processor 154. Presentation interface 156 presents information, such as images, to a user. In one embodiment, presentation interface 156 includes a display adapter (not shown) coupled to a display device (not shown), such as a cathode ray tube (CRT), a liquid crystal display (LCD), an organic LED (OLED) display, or an “electronic ink” display. In some embodiments, presentation interface 156 includes one or more display devices. In addition, or alternatively, presentation interface 156 includes an audio output device (not shown), for example, without limitation, an audio adapter or a speaker (not shown).

In some embodiments, controller 118 includes a user input interface 158. In the exemplary embodiment, user input interface 158 is coupled to processor 154 and receives input from the user. In some embodiments, user input interface 158 includes, for example, without limitation, a keyboard, a pointing device, a mouse, a stylus, a touch sensitive panel, such as, without limitation, a touch pad or a touch screen, and/or an audio input interface, such as, without limitation, a microphone. In further embodiments, a single component, such as a touch screen, functions as both a display device of presentation interface 156 and user input interface 158.

In the exemplary embodiment, a communication interface 160 is coupled to processor 154 and is configured to couple in communication with one or more other devices, such as particulate delivery system 116, and to perform input and output operations with respect to such devices while performing as an input channel. For example, in some embodiments, communication interface 160 includes, without limitation, a wired network adapter, a wireless network adapter, a mobile telecommunications adapter, a serial communication adapter, or a parallel communication adapter. Communication interface 160 receives a data signal from or transmits a data signal to one or more remote devices.

Presentation interface 156 and communication interface 160 are both capable of providing information for use with the methods described herein, such as, providing information to the user and/or processor 154. Accordingly, presentation interface 156 and communication interface 160 are referred to as output devices. Similarly, user input interface 158 and communication interface 160 are capable of receiving information for use with the methods described herein and are referred to as input devices.

In reference to FIGS. 1-3, an exemplary method of manufacturing a part using additive manufacturing system 100 includes depositing first particulates 122 on surface 120. In some embodiments, the method includes displacing first particulates 122 to form recess 134. The method also includes depositing second particulates 124 onto surface 120 adjacent first particulates 122. In some embodiments, second particulates 124 are deposited at least partially within recess 134. In further embodiments, second particulates 124 are deposited at the same time as first particulates 122 are displaced. At least one of first particulates 122 and second particulates 124 is heated using focused energy source 102. In some embodiments, first particulates 122 are heated using focused energy source 102 prior to depositing second particulates 124 on surface 120. In some embodiments, focused energy source 102 is directed to heat second particulates 124 as second particulates 124 are deposited. In further embodiments, at least some steps are repeated to form a component from first particulates 122 and second particulates 124 having multiple layers.

FIG. 5 is a schematic view of an embodiment of a particulate delivery system 200 for use with additive manufacturing system 100 (shown in FIG. 1). Particulate delivery system 200 includes a plurality of particulate supplies or hoppers 202, a regulation assembly 204, a dispenser 206, and a plurality of supply lines 208. Particulate delivery system 200 is configured to deposit at least one type of particulates 210 onto surface 120. In the exemplary embodiment, particulate delivery system 200 deposits first particulates 210, second particulates 210, and third particulates 210. In alternative embodiments, particulate delivery system 200 is configured in any manner that enables particulate delivery system 200 to operate as described herein. For example, in some embodiments, particulate delivery system 200 deposits fourth particulates 210. In further embodiments, particulate delivery system 200 deposits any number of particulates 210.

In the exemplary embodiment, each particulate supply 202 is coupled to dispenser 206 by a corresponding supply line 208. Accordingly, particulate supplies 202 facilitate dispenser 206 depositing different particulates 210 onto surface 120. Regulation assembly 204 is coupled to supply lines 208 and regulates which particulates 210 are supplied to dispenser 206 for depositing onto surface 120. Regulation assembly 204 is selectively positionable between opened positions where each particulates 210 is selectively allowed to flow to dispenser 206 and a closed position where particulates 210 are inhibited from flowing into dispenser 206. In the exemplary embodiment, regulation assembly 204 includes a valve 212 coupled to supply lines 208 adjacent dispenser 206. The configuration of regulation assembly 204 minimizes the response time of particulates 210 flow from dispenser 206 when regulation assembly 204 is moved between the opened and closed positions. In alternative embodiments, particulate delivery system 200 includes any regulation assembly 204 that enables particulate delivery system 200 to operate as described herein.

Also, in the exemplary embodiment, dispenser 206 includes a nozzle 214 configured to dispense particulates 210 onto surface 120. Nozzle 214 includes a body 216. Body 216 defines a surface 218 and an opening 220 in surface 218 for particulates 210 to flow through. Nozzle 214 regulates the amount and direction of particulates 210 that is dispensed from dispenser 206. In alternative embodiments, particulate delivery system 200 includes any dispenser 206 that enables particulate delivery system 200 to operate as described herein. For example, in some embodiments, particulate delivery system 200 includes a plurality of nozzles 214.

In addition, in the exemplary embodiment, dispenser 206 facilitates building components from multiple particulates 210. In particulate, dispenser 206 selectively deposits different particulates 210 in specific locations. For example, in some embodiments, dispenser 206 deposits particulates 210 into recess 134 (shown in FIG. 4). In further embodiments, different particulates 210 are deposited adjacent each other. For example, different particulates 210 are deposited in contact with each other within the same layer. In addition, in some embodiments, different particulates 210 are deposited simultaneously and form a composition of particulates 210. Regulation assembly 204 defines the dose of each particulates 210 that is deposited onto surface 120. Accordingly, particulate delivery system 200 allows for the use of any composition(s) of particulates 210 to build a component. In addition, particulate delivery system 200 facilitates the localization of properties in a component.

Moreover, in the exemplary embodiment, a fusing apparatus 222 is provided to facilitate fusing particulates 210. Specifically, fusing apparatus 222 includes a dispenser (e.g., a print head) 224 configured to deposit a binder 226 onto particulates 210. In alternative embodiments, system 100 (shown in FIG. 1) includes any fusing apparatus 222 that enables system 100 to operate as described herein.

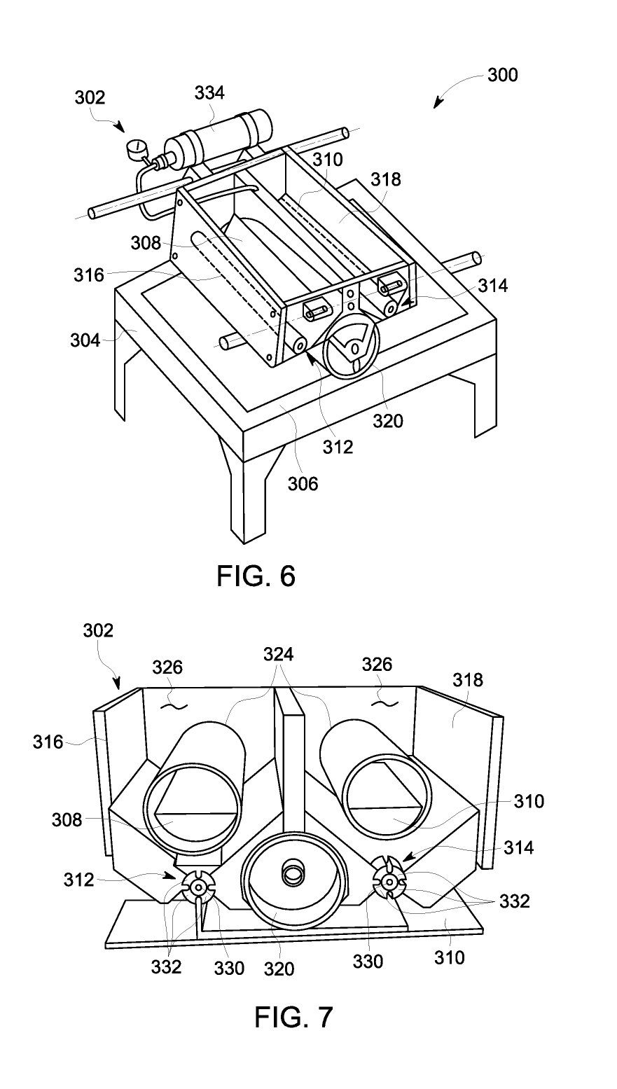

FIG. 6 is a perspective view of an exemplary additive manufacturing system 300. In the exemplary embodiment, additive manufacturing system 300 includes a particulate delivery system 302 and a housing 304. Housing 304 defines a surface or build plate 306 configured to hold first particulates 308 and second particulates 310. In addition, additive manufacturing system 300 includes a source 334 of pressurized gas to facilitate cleaning components of particulate delivery system 302 such as shafts 330 of first dispenser 312 (shown in FIG. 7) and/or second dispenser 314 (shown in FIG. 7). In alternative embodiments, additive manufacturing system 300 includes any component that enables additive manufacturing system 300 to operate as described herein.

In addition, in the exemplary embodiment, first particulates 308 and second particulates 310 are powdered build materials that are melted and re-solidified during the additive manufacturing process to build a solid component. In the exemplary embodiment, first particulates 308 and second particulates 310 each include a gas-atomized alloy of any of the following: cobalt, iron, aluminum, titanium, nickel, and combinations thereof. In alternative embodiments, first particulates 308 and second particulates 310 include any material that enables additive manufacturing system 300 to operate as described herein. For example, in some embodiments, first particulates 308 and/or second particulates 310 include, without limitation, any of the following: ceramic powders, metal-coated ceramic powders, thermoset resins, and thermoplastic resins. In further embodiments, additive manufacturing system 300 utilizes any number of particulates, e.g., third particulates, fourth particulates, etc.

FIG. 7 is a perspective view of particulate delivery system 302 of additive manufacturing system 300. Particulate delivery system 302 includes a first dispenser 312, a second dispenser 314, a first particulate supply 316, and a second particulate supply 318. In the exemplary embodiment, first dispenser 312 and second dispenser 314 are positioned above surface 306 (shown in FIG. 6) and configured to deposit first particulates 308 and second particulates 310 onto surface 306. In particular, first dispenser 312 is coupled to first particulate supply 316 and configured to dispense first particulates 308 from first particulate supply 316 onto surface 306. Second dispenser 314 is coupled to second particulate supply 318 and is configured to dispense second particulates 310 from second particulate supply 318 onto surface 306. Accordingly, first dispenser 312 and second dispenser 314 facilitate depositing different particulates 308, 124 onto surface 306. In alternative embodiments, particulate delivery system 302 has any configuration that enables additive manufacturing system 300 to operate as described herein. For example, in some embodiments, particulate delivery system 302 includes a powder bed and a transfer mechanism to deposit at least one of first particulates 308 and second particulates 310 onto surface 306.

In addition, in the exemplary embodiment, first particulate supply 316 and second particulate supply 318 are configured to hold first particulates 308 and second particulates 310 within interior spaces 326. Screens 324 are rotatably coupled to first particulate supply 316 and second particulate supply 318 and disposed within interior spaces 326. Screens 324 rotate in contact with particulates 308, 310 and provide a continuous supply of screened particulates 308, 310 to dispensers 312, 314. In alternative embodiments, particulate delivery system 302 includes any first particulate supply 316 and/or second particulate supply 318 that enables particulate delivery system 302 to operate as described herein.

Also, in the exemplary embodiment, particulate delivery system 302 includes a roller 320 to facilitate depositing first particulates 308 and second particulates 310 onto surface 306. Roller 320 is positioned between first dispenser 312 and second dispenser 314. In alternative embodiments, particulate delivery system 302 includes any roller 320 that enables particulate delivery system 302 to operate as described herein. In some embodiments, roller 320 is omitted.

Also, in the exemplary embodiment, first dispenser 312 and second dispenser 314 each include a shaft 330 configured to rotate about an axis. Each shaft 330 includes a plurality of grooves 332. As shafts 330 rotate, particulates 308, 310 are collected in respective grooves 332 and dispensed to surface 306. In alternative embodiments, particulate delivery system 302 includes any dispenser 312, 314 that enables particulate delivery system 302 to operate as described herein. For example, in some embodiments, particulate delivery system 302 includes one or more nozzles.

Moreover, in the exemplary embodiment, particulate delivery system 302 is configured to move relative to surface 306. In particular, first dispenser 312 and second dispenser 314 are configured to move laterally relative to surface 306. In addition, first dispenser 312 and second dispenser 314 are configured to move towards and away from surface 306. Accordingly, particulate delivery system 302 is configured to deposit at least one of first particulates 308 and second particulates 310 in any pattern on surface 306. First particulate supply 316 and second particulate supply 318 are coupled to first dispenser 312 and second dispenser 314 and are configured to move with first dispenser 312 and second dispenser 314. In alternative embodiments, particulate delivery system 302 is configured to move in any manner that enables additive manufacturing system 300 to operate as described herein.

In addition, in the exemplary embodiment, particulate delivery system 302 facilitates building components from multiple particulates 308, 310. In particulate, particulate deliver system 302 selectively deposits different particulates 308, 310 in specific locations. For example, in some embodiments, particulate delivery system 302 deposits particulates 308, 310 into recess 134 (shown in FIG. 4). In further embodiments, different particulates 308, 310 are deposited adjacent each other, e.g., in contact with each other. Particulate delivery system 302 defines the dose of each particulate 308, 310 that is deposited onto surface 306. Accordingly, additive manufacturing system 300 allows for the use of any composition(s) of particulates 308, 310 to build a component. In addition, additive manufacturing system 300 facilitates the localization of properties in a component.

Additive manufacturing processes and systems include, for example, and without limitation, vat photopolymerization, powder bed fusion, binder jetting, material jetting, sheet lamination, material extrusion, directed energy deposition and hybrid systems. These processes and systems include, for example, and without limitation, SLA—Stereolithography Apparatus, DLP—Digital Light Processing, 3SP—Scan, Spin, and Selectively Photocure, CLIP—Continuous Liquid Interface Production, SLS—Selective Laser Sintering, DMLS—Direct Metal Laser Sintering, SLM—Selective Laser Melting, EBM—Electron Beam Melting, SHS—Selective Heat Sintering, MJF—Multi-Jet Fusion, 3D Printing, Voxeljet, Polyjet, SCP—Smooth Curvatures Printing, MJM—Multi-Jet Modeling Projet, LOM—Laminated Object Manufacture, SDL—Selective Deposition Lamination, UAM—Ultrasonic Additive Manufacturing, FFF—Fused Filament Fabrication, FDM—Fused Deposition Modeling, LIVID—Laser Metal Deposition, LENS—Laser Engineered Net Shaping, DMD—Direct Metal Deposition, Hybrid Systems, and combinations of these processes and systems. These processes and systems may employ, for example, and without limitation, all forms of electromagnetic radiation, heating, sintering, melting, curing, binding, consolidating, pressing, embedding, and combinations thereof.

Additive manufacturing processes and systems employ materials including, for example, and without limitation, polymers, plastics, metals, ceramics, sand, glass, waxes, fibers, biological matter, composites, and hybrids of these materials. These materials may be used in these processes and systems in a variety of forms as appropriate for a given material and the process or system, including, for example, and without limitation, as liquids, solids, powders, sheets, foils, tapes, filaments, pellets, liquids, slurries, wires, atomized, pastes, and combinations of these forms.”

The above described systems and methods relate to additive manufacturing systems, such as Direct Metal Laser Melting (DMLM) systems. The embodiments described herein include a focused energy source and a particulate delivery system. The particulate delivery system is configured to deposit a plurality of first particulates and a plurality of second particulates onto a surface. In some embodiments, the particulate delivery system includes at least one dispenser configured to dispense the first particulates and the second particulates. In further embodiments, at least a portion of the first particulates are displaced to at least partially form a recess and at least a portion of the second particulates are deposited at least partially into the recess. Accordingly, the described embodiments allow components to have localized properties. For example, different particulates are included within the same layer during a build of the component to facilitate localization of properties within the component.

An exemplary technical effect of the methods and systems described herein includes at least one of: (a) providing components having localized properties; (b) reducing the time and resources required to assemble components; (c) reducing the risk of failure of components; (d) providing components including different particulates within the same layer; and (e) providing particulate delivery systems for depositing multiple particulates onto a surface.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device, and/or a memory device. Such instructions, when executed by a processing device, cause the processing device to perform at least a portion of the methods described herein. The above examples are exemplary only, and thus are not intended to limit in any way the definition and/or meaning of the term processor and processing device.

Although specific features of various embodiments of the invention may be shown in some drawings and not in others, this is for convenience only. In accordance with the principles of the invention, any feature of a drawing may be referenced or claimed in combination with any feature of any other drawing.

Exemplary embodiments for enhancing the build parameters for making additive manufactured components are described above in detail. The apparatus, systems, and methods are not limited to the specific embodiments described herein, but rather, operations of the methods and components of the systems may be utilized independently and separately from other operations or components described herein. For example, the systems, methods, and apparatus described herein may have other industrial or consumer applications and are not limited to practice with components as described herein. Rather, one or more embodiments may be implemented and utilized in connection with other industries.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An additive manufacturing system comprising:
a particulate delivery system comprising:
at least one dispenser configured to dispense a plurality of first particulates and a plurality of second particulates onto a surface;
a first particulate supply coupled to said at least one dispenser; and
a second particulate supply coupled to said at least one dispenser,
wherein said at least one dispenser is configured to deposit the plurality of first particulates and the plurality of second particulates adjacent each other, and wherein
at least a portion of at least one of the plurality of first particulates and the plurality of second particulates is fused.

2. The additive manufacturing system in accordance with claim 1,
wherein said particulate delivery system comprises a regulation assembly coupled to said first particulate supply and said second particulate supply, said regulation assembly configured to regulate said first particulate supply and said second particulate supply to said at least one dispenser.

3. The additive manufacturing system in accordance with claim 2,
wherein said regulation assembly comprises at least one valve.

4. The additive manufacturing system in accordance with claim 1 further comprising a displacement assembly configured to displace at least a portion of the plurality of first particulates on the surface and at least partially form a recess.

5. The additive manufacturing system in accordance with claim 1,
wherein said at least one dispenser comprises a nozzle.

6. The additive manufacturing system in accordance with claim 1,
wherein said at least one dispenser comprises a first dispenser and a second dispenser.

7. The additive manufacturing system in accordance with claim 1,
further comprising at least one focused energy source configured to heat at least a portion of at least one of the plurality of first particulates and the plurality of second particulates.

8. The additive manufacturing system in accordance with claim 1,
further comprising a binder dispenser configured to deposit a binder onto at least a portion of at least one of the plurality of first particulates and the plurality of second particulates.

9. A method of manufacturing a part using an additive manufacturing system, said method comprising:
depositing a plurality of first particulates;
depositing a plurality of second particulates, wherein the plurality of second particulates is deposited adjacent the plurality of first particulates; and
heating at least a portion of at least one of the plurality of first particulates and the plurality of second particulates using a first focused energy source.

10. The method in accordance with claim 9, further comprising
displacing at least a portion of the plurality of first particulates to at least partially form a recess, wherein the plurality of second particulates is deposited at least partially within the recess.

11. The method in accordance with claim 10, wherein depositing a plurality of second particulates occurs simultaneously with displacing the plurality of first particulates to form a recess.

12. The method in accordance with claim 9, wherein heating at least a portion of at least one of the plurality of first particulates and the plurality of second particulates using the first focused energy source comprises heating at least a portion of the plurality of first particulates using the first focused energy source prior to depositing the plurality of second particulates.

13. The method in accordance with claim 12 further comprising
heating the plurality of second particulates using a second focused energy source.

14. The method in accordance with claim 9 further comprising
moving a first dispenser relative to a surface, the first dispenser configured to dispense the plurality of first particulates onto the surface.

15. The method in accordance with claim 14 further comprising
moving a second dispenser relative to the surface, the second dispenser configured to dispense the plurality of second particulates onto the surface.

16. An additive manufacturing system comprising:
a displacement assembly configured to displace at least a portion of a plurality of first particulates and at least partially form a recess;
at least one dispenser configured to dispense a plurality of second particulates, wherein said at least one dispenser is configured to dispense at least a portion of the plurality of second particulates at least partially into the recess; and
at least one focused energy source configured to heat at least a portion of at least one of the plurality of first particulates and the plurality of second particulates.

17. The additive manufacturing system in accordance with claim 16,
wherein said at least one dispenser is coupled to said displacement assembly and is configured to dispense the plurality of second particulates as the displacement assembly displaces the plurality of first particulates.

18. The additive manufacturing system in accordance with claim 16,
wherein said displacement assembly comprises a tool configured to contact at least a portion of the first particulates.

19. The additive manufacturing system in accordance with claim 16,
wherein said displacement assembly comprises a vacuum system configured to remove a portion of the plurality of first particulates.

20. The additive manufacturing system in accordance with claim 16,
wherein said at least one dispenser comprises a first dispenser and a second dispenser.
